(19) United States
(12) Patent Application Publication
(10) Pub. No.: US 2006/0063597 A1
(43) Pub. Date: Mar. 23, 2006

(54) Sealing assembly

(76) Inventors: Herbert Cermak, Bessenbach (DE); Wolfgang Lobel, Frankfurt/Main (DE)

Correspondence Address: Robert P. Renke, Suite 250, 28333 Telegraph Road, Southfield, MI, 48034, US

(21) Appl. No.: 11/230,434

(22) Filed: Sep. 20, 2005

(30) Foreign Application Priority Data
Sep. 22, 2004 (DE) 10 2004 045 824.3
Feb. 27, 2004 (DE) 10 2004 009 477.2

(51) Int. Cl. F16D 3/16

(52) U.S. Cl. 464/146

(57) ABSTRACT

A sealing assembly at a constant velocity joint having an annular outer joint part (11) which is open at both ends and having a sealing cover (31) which sealingly rests against an end face (19) of the outer joint part (11) and is positioned on the circumference of the outer joint part (11) with pretension, wherein the sealing cover (31) comprises individual circumferentially distributed tongues (34) which rest on the circumference of the outer joint part (11) and wherein an attaching flange (41) is bolted to the outer joint part (11) and to the sealing cover (31) which comprises a centering collar (42) which is positioned between the respective tongues (34) directly on the outer joint part (11).

### TECHNICAL FIELD

The invention relates to a sealing assembly for a constant velocity joint having an annular outer point part which is open at both ends, and having a sealing cover which sealingly rests against an end face of the outer joint part and is positioned on the circumference of the outer joint part with pretension.

### BACKGROUND OF THE INVENTION

With joints of the above-mentioned type which are also referred to as disc joints, the mounted joint filled with grease is sealed at one end by a shaft inserted into the inner joint part and by a convoluted boot and, at the other end, by a sealing cover consisting of plate metal or plastics. More particularly, during transport and up to the point of the final assembly, said sealing cover has to be firmly positioned on the outer joint part, because it is only during the final assembly stage to an attaching flange that the sealing cover is clamped in between the outer joint part and the attaching flange and is thus held in such a way that it cannot be lost. If a cylindrical portion of the sealing cover, which extends over the outer joint part, is produced so as to be relatively long, it provides a high degree of security, but it also involves higher production costs, high assembly forces and long assembly distances. If the respective cylindrical portion is produced so as to be short, both production and assembly are simplified, but it is not adequately protect against unintentional release prior to the final assembly. Thus, there exits a need for a robust, simplified, and inexpensive sealing cover for disc-type constant velocity joints.

### SUMMARY OF THE INVENTION

The present invention provides a sealing assembly for a disc-type constant velocity joint which improves assembly and provides greater security against the sealing cover being lost. The assembly also provides improved possibilities for centering the outer joint part and the attaching flange. The sealing cover comprises individual circumferentially distributed axially extending tongues which rest on the circumference of the outer joint part. An attaching flange is bolted to the outer joint part and to the sealing cover which comprises a centering collar which is directly supported on the outer joint part between the respective tongues. The inventive tongues can be produced in a relatively long axial length without, as a result, considerably increasing the axial forces required for assembly purposes. The increased axial length makes it less likely that the sealing cover will become lost. The tongues rest in a planar way against correspondingly shaped circumferential faces of the outer joint part.

According to an advantageous embodiment, the outer joint part comprises a cylindrically extending circumferential face, and the centering collar of the attaching flange comprises circumferentially distributed recesses in the region of the tongues.

According to a further advantageous embodiment, the outer joint part comprises a circumferential face with individual circumferentially distributed flattened regions on which there rest the tongues, and the centering collar of the attaching flange is designed so as to be circumferentially continuous.

Both embodiments ensure that direct centering can take place between the outer joint part and the attaching flange, which centering measure is unaffected by the sealing cover clamped in between the outer joint part and the attaching flange. In the first case, in the circumferential regions provided for the tongues, the centering collar comprises corresponding recesses, so that the centering collar, as a whole, is formed of individual portions engaging between the tongues. In the second case, the centering collar is designed so as to be circumferentially continuous, but in the regions occupied by the tongues, there occurs a radial gap to the outer joint part, so that centering itself again only takes place in the circumferential regions between the tongues.

According to a further advantageous embodiment, a transversely extending inner undulation is provided at the tongues. At the outer circumference of the outer joint part, on the circumferential face or at the flattened portions, there is formed at least one circumferential groove which is axially securingly engaged by the inner undulations of the tongues.

In this way, it is possible to improve the axial holding forces of the sealing cover relative to the outer joint part prior to mounting the attaching flange.

According to yet a further embodiment, additional seals are inserted between a bolting face of the sealing cover and an end face of the outer joint part. Several embodiments are contemplated for such seals, with the simplest being a sealing ring inserted into an annular groove.

Other advantages and features of the invention will also become apparent upon reading the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 shows an inventive sealing assembly in a first embodiment in an angled longitudinal section.

FIG. 2 shows the sealing assembly according to FIG. 1 in an end view.

FIG. 3 shows the sealing assembly according to FIGS. 1 and 2 in a perspective view.

FIG. 4 shows an inventive sealing assembly in a second embodiment in a planar longitudinal section.

FIG. 5 shows the sealing assembly according to FIG. 4 in an end view.

FIG. 6 shows the sealing assembly according to FIGS. 4 and 5 in a perspective view.

FIG. 7 shows the sealing assembly similar to FIG. 4 in a radial partial view.

FIG. 8 shows an enlarged detail of FIG. 7.

FIG. 9 shows a detail which is modified as compared to FIG. 8.

### DETAILED DESCRIPTION OF THE DRAWINGS

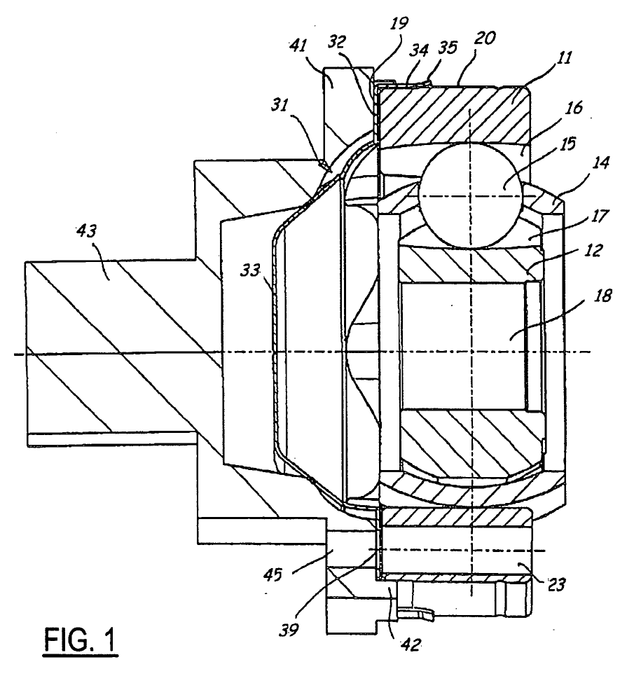

FIG. 1 shows a constant velocity universal joint having an annular outer joint part 11 which is open at both ends, an inner joint part 12 arranged therein, a ball cage 14 and one of a plurality of circumferentially distributed torque transmitting balls 15 in a longitudinal section. The balls are positioned in outer tracks 16 in the outer joint part 11 and in inner tracks 17 in the inner joint part 12. The tracks are positioned in pairs opposite one another. At the inner joint part 12, there is provided an insertion aperture 18 for inserting an attaching shaft. On to the outer joint part 11, there has been placed a sealing cover 31 which sealingly rests against an end face 19 of the outer joint part 11 and which is positioned in a radially pretensioned way on a cylindrical circumferential face 20 of the outer joint part 11. The sealing cover 31 comprises an annular planar sealing face 32, individual, cylindrically curved tongues 34 starting therefrom, as well as a fully formed sealing cap 33. The free ends of the introducing inclinations 35 are bent open at the tongues 34. An attaching flange 41 forming a centering collar 43 is placed against the sealing cover 31. The centering collar 42 is interrupted in the circumferential region of the tongues. The attaching flange 41 is connected to an attaching journal 43. The outer joint part 12, the sealing cover 31 and the attaching flange 41 are axially secured relative to one another by a bolted connection (not illustrated). However, the bolt holes 23 in the outer joint part 11, the bolt holes 39 in the sealing cover 31 and the bolt holes 45 in the attaching flange 41 are shown.

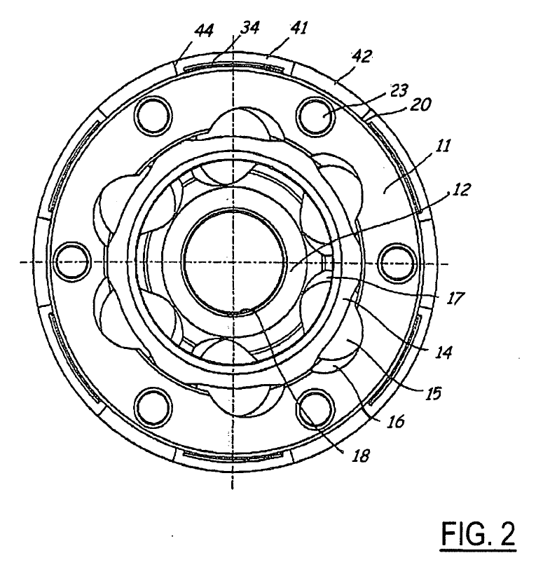

In FIG. 2, any details identical to those shown in FIG. 1 have been given the same reference numbers as in FIG. 1. To that extent, reference is made to the preceding description. It can be seen that the tongues 34 are cylindrically curved and, in a planar way, rest against the cylindrical circumferential face 20 of the outer joint part 11. In this example, the tongues 34 engage less than half and, more particularly, approximately one-third of the axial length of the cylindrical circumferential face 20 of the outer joint part 11. Furthermore, it can be clearly seen that six uniformly circumferentially distributed tongues 34 are positioned on the outer joint part 11. Of course, more or fewer tongues could be used depending upon the application under consideration. The centering collar 42 of the flange 41 comprising circumferentially distributed recesses engages between each two tongues. This demonstrates that the sealing cover 31 can be placed in a radially pretensioned condition and in a self-holding way on to the outer joint part 11, so that the joint is sealed, more particularly for transport purposes, whereas the final axial security is achieved by bolting the attaching flange 41 to the sealing cover 31 and to the outer joint part 11. Accurate centering of the flange 41 relative to the outer joint part 11 is in no way obstructed by the sealing cover 31.

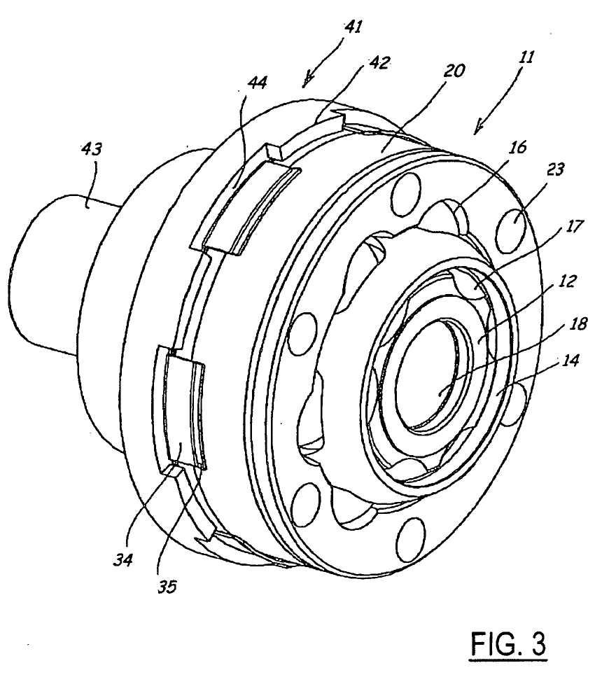

In FIG. 3, details identical to those shown in FIGS. 1 and 2 have been given the same reference numbers. To that extent, reference is made to the preceding description. The constant velocity joint shown is a VL plunging joint. It can be seen particularly clearly that the tongues 34 of the sealing cover 31 engage the recesses 44 of the centering collar 42 of the flange 41. The sealing cover is clamped in entirely axially. The flange 41 is centered directly relative to the outer joint part 11 without the sealing cover 31 adversely affecting the accurate centric position.

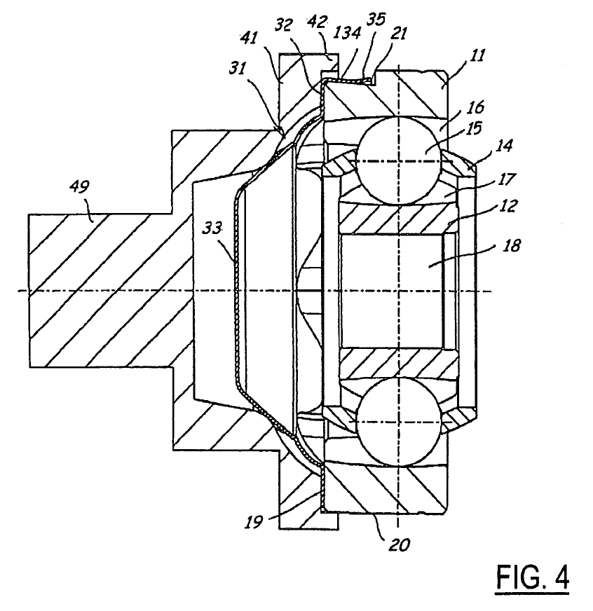

FIG. 4 shows an outer joint part 11 of a constant velocity universal joint, on to which outer joint part 11 there is placed a sealing cover 31 which also comprises a fully formed sealing cap 33 and individual circumferentially distributed straight-edged planar tongues 134. The straight-edged planar tongues 134, in a first embodiment, comprise introducing inclinations 35. The outer joint part 11 in this figure deviates from that of FIGS. 1-3 in that it comprises planar secant flattened portions 21 which are introduced into the cylindrical circumferential face 20 and on which, in a planar way, there rest the tongues 134 which are also planar. The flattened portions 21 and the tongues 134 do not extend at right angles relative to the end face 19 and to the sealing face 32, but extend inwardly from the base edge, thus providing more security in order to prevent the outer joint part and the sealing cover from being separated.

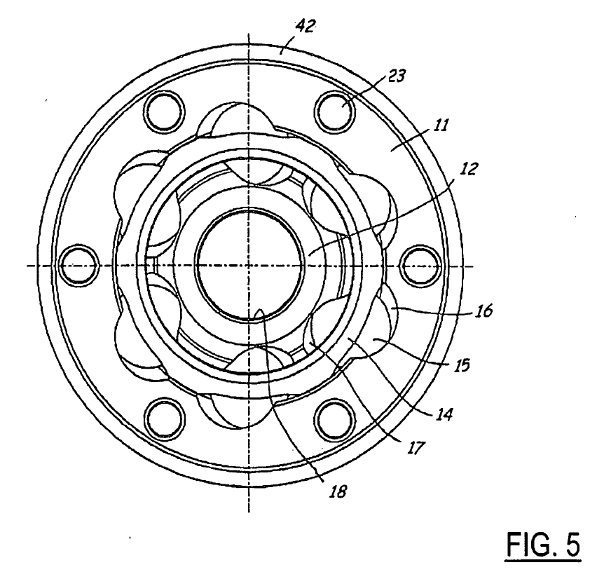

In FIG. 5, any details identical to those shown in FIG. 4 have been given the same reference numbers. The three circumferentially distributed tongues 34 have been countersunk into the flattened portions 21 and are therefore not visible. The centering collar 42 is fully annular and, around the entire circumference, is positioned on the cylindrical circumferential face 20 of the outer joint part 11. Centering therefore cannot be adversely affected by the tongues 134.

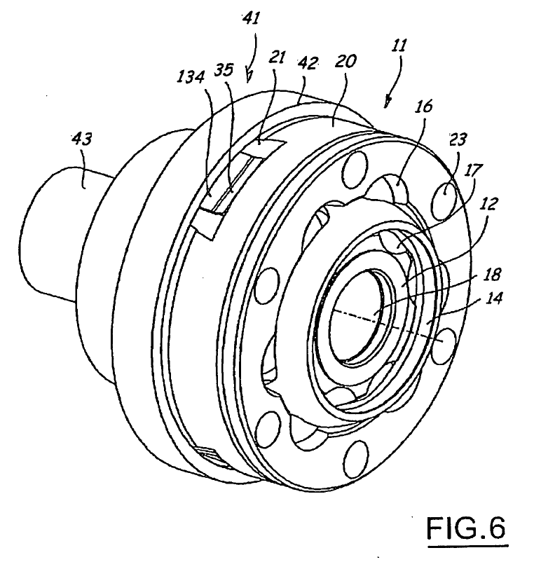

In FIG. 6, any details identical to those shown in FIG. 5 have been given the same reference numbers. To that extent, reference is made to the description of FIGS. 4 and 5. In particular, it can be clearly seen that the centering collar 42 is continuously positioned on the circumferential face 20 of the outer joint part 11 and, that, unobstructed thereby, the tongues 134 emerge underneath the centering collar 42 and rest against the secant flattened portions 21 on the outside of the outer joint part 11. Furthermore, it can be seen that there are provided only three circumferentially distributed tongues 134 and that these are planar. Again, more or fewer tongues 134 could be provided. Typically, however, the number of tongues 34, 134 would range between two and ten and, more particularly, between three and six.

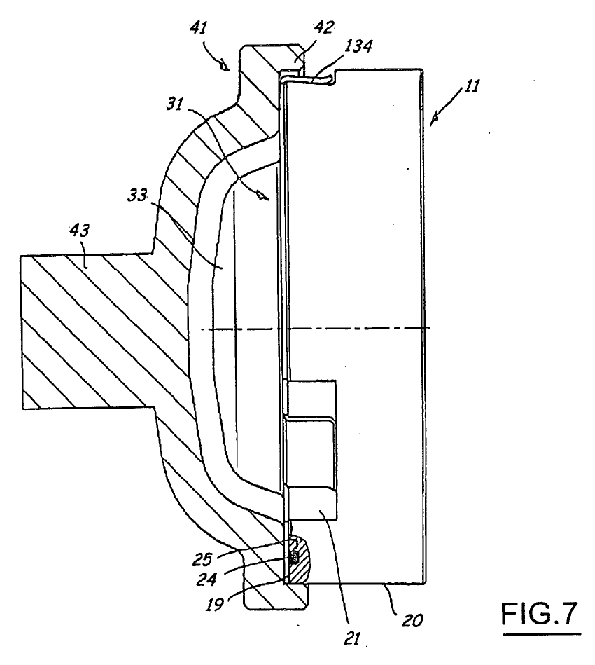

In FIG. 7, any details identical those in FIGS. 4 to 6 have been given the same reference numbers. To that extent, reference is made to the description of same. The attaching flange 41 comprises a slightly deviating shape, with the centering collar 42, in this case, too, being continuously annular in shape. It is possible to see the secant flattened portions 21 and the tongues 134 resting thereon which each extend inwardly from the base edge. In addition, it can be seen that in the sealing face 19 of the outer joint part 11, there is provided an annular groove 25 which accommodates a sealing ring 24 which seals the outer joint part 11 relative to the sealing cover 31. The seal can be improved by additional sealing rings 24.

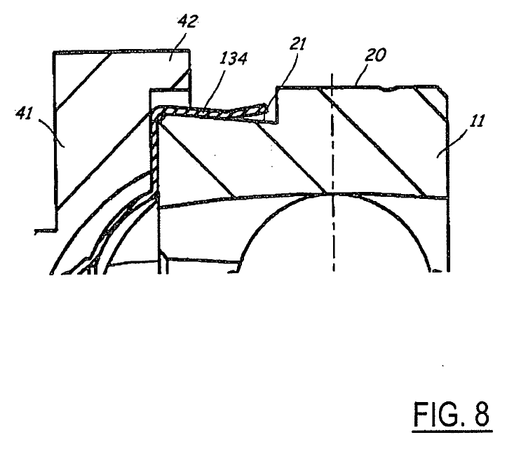

FIG. 8 shows one of the secant flattened portions 21 and the associated tongue 134 according to FIG. 4 in the form of an enlarged detail. To that extent, reference is made to the description of same.

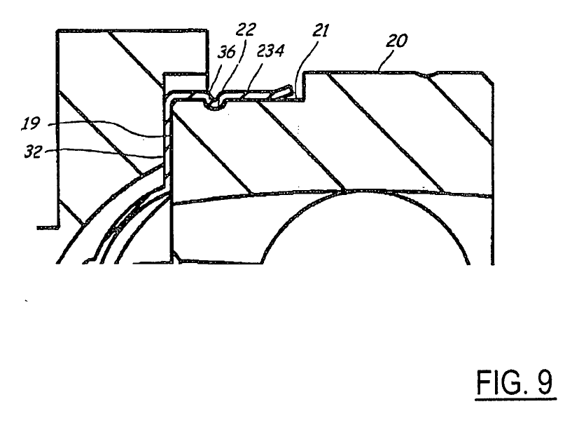

FIG. 9 deviates from FIG. 8 in that the secant flattened portions 21 and the tongues 234 are formed at right angles relative to the radial faces 19, 32, and, for the purpose of increasing the axial securing forces, there is formed in a transverse groove 22 into each flattened portion 21 and a matching inner recess 36 into each tongue 234 to engage the same.

While the invention has been described in connection with several embodiments, it should be understood that the invention is not limited to those embodiments. Thus, the invention covers all alternatives, modifications, and equivalents as may be included in the spirit and scope of the appended claims.

What is claimed is:

1. A sealing assembly for a constant velocity joint having an annular outer joint part open at both ends, at least one end providing an end face and an outer circumference, the assembly comprising:
a sealing cover for sealingly abutting the end face and adapted to be positioned on the outer circumference of the outer joint part, the sealing cover comprising separate circumferentially distributed tongues for engaging the outer circumference; and
an attaching flange adapted to be bolted to the outer joint part and sealing cover, the attaching flange comprising a centering collar for positioning between respective tongues directly on the outer joint part.

2. A sealing assembly according to claim 1, wherein the outer circumference of the outer joint part is cylindrical, and wherein the centering collar, in the region of the tongues, comprises separate circumferentially distributed recesses.

3. A sealing assembly according to claim 1, wherein the outer circumference of the outer joint part includes circumferentially distributed flat portions for receiving the tongues, and wherein the centering collar is circumferentially continuous.

4. A sealing assembly according to claim 1, wherein at least one of the tongues includes a transversely extending inner recess for engaging a groove on the outer circumference of the outer joint part.

5. A sealing assembly according to claim 2, wherein at least one of the tongues includes a transversely extending inner recess for engaging a groove on the outer circumference of the outer joint part.

6. A sealing assembly according to claim 3, wherein at least one flat portion includes a circumferential groove, and wherein at least one of the tongues includes a transversely extending inner recess for engaging said at least one groove.

7. A sealing assembly according to claim 1, comprising a seal between a bolting face of the sealing cover and said end face of the outer joint part.

8. A sealing assembly according to claim 2, comprising a seal between a bolting face of the sealing cover and said end face of the outer joint part.

9. A sealing assembly according to claim 3, comprising a seal between a bolting face of the sealing cover and said end face of the outer joint part.

10. A sealing assembly according to claim 4, comprising a seal between a bolting face of the sealing cover and said end face of the outer joint part.

11. A sealing assembly according to claim 1 comprising three to six tongues.

12. A sealing assembly according to claim 2 comprising three to six recesses.

13. A sealed constant velocity joint comprising:
an outer joint part open at both ends, at least one end providing an end face and an outer circumference:
a sealing cover sealingly abutting the end face and positioned on the outer circumference of the outer joint part with pretension, the sealing cover comprising separate circumferentially distributed tongues for engaging the outer circumference; and
an attaching flange bolted to the outer joint part and sealing cover, the attaching flange comprising a centering collar positioned between respective tongues directly on the outer joint part.

14. A sealed constant velocity joint according to claim 13, wherein the outer circumference of the outer joint part is cylindrical, and wherein the centering collar, in the region of the tongues, comprises separate circumferentially distributed recesses.

15. A sealed constant velocity joint according to claim 13, wherein the outer circumference of the outer joint part includes circumferentially distributed flat portions for receiving the tongues, and wherein the centering collar is circumferentially continuous.

16. A sealed constant velocity joint according to claim 13, wherein at least one of the tongues includes a transversely extending inner recess engaging a groove on the outer circumference of the outer joint part.

17. A sealed constant velocity joint according to claim 14, wherein at least one of the tongues includes a transversely extending inner recess engaging a groove on the outer circumference of the outer joint part.

18. A sealed constant velocity joint according to claim 15, wherein at least one flat portion includes a circumferential groove, and wherein at least one of the tongues includes a transversely extending inner recess engaging said at least one groove.

19. A sealed constant velocity joint according to claim 13 comprising a seal between a bolting face of the sealing cover and said end face of the outer joint part.

20. A sealed constant velocity joint according to claim 13 comprising three to six tongues.
